(19) United States
(12) Patent Application Publication
(10) Pub. No.: US 2009/0262078 A1
(43) Pub. Date: Oct. 22, 2009

(54) Cellular phone with special sensor functions

(76) Inventor: David Pizzi, Pfaeffikon SZ (CH)

Correspondence Address: David Pizzi, Sonnenhof 20, Pfaeffikon SZ, 8808, omitted

(21) Appl. No.: 12/106,808

(22) Filed: Apr. 21, 2008

(51) Int. Cl. G06F 3/02

(52) U.S. Cl. 345/169

(57) ABSTRACT

Specific ambient and user behaviour sensing systems and methods are presented to improve friendliness and usability of electronic handheld devices, in particular cellular phones, PDAs, multimedia players and similar.

The improvements and special functions include following components:
a. The keypad is locked/unlocked (disabled/enabled) and/or the display activated based on the device inclination relative to its longitudinal and/or lateral axes.
b. The keypad is locked if objects are detected above the display (for example the boundary of a bag or pursue).
c. The keypad is locked/unlocked (disabled/enabled) and/or the display activated based on electric field displacement or bio-field sensing systems recognizing the user hand in any position behind the handheld device.
d. The electric response signal generated by an electric field through the user hand in contact with a receiver plate is used to identify the user and in negative case lock the device.
e. Connection with incoming calls is automatically opened as soon as a hand is detected behind the device and the device is put close to the ear (proximity sensor).
f. The profile (ring-tone mode, volume and silent mode) can be changed just putting the device in a specific verse (upside up or upside down).
g. Has a lateral curved touchpad with tactile markings over more surfaces to control a mouse pointer/cursor or selection with the thumb finger.

### BACKGROUND OF THE INVENTION

1. Field of the Invention

This invention relates generally to mobile and cellular phones and terminals with a keypad (or a user input interface), a display and a set of internal and external sensors.

Cellular phone usage in the United States has reached a critical mass, with almost two-thirds of American adults now owning a cellular phone, according to a recent study from Scarborough Research. This represents a 29% growth rate of cellular phone ownership over the past two years. This growth is likely to continue, since 9% of American adults plan to purchase a cell phone in the next year.

Mobile phones are becoming objects everyone has and everyone has always with himself, just as wristwatches. They are used very frequently during the whole day for many functions, from phoning to agenda, from sending and receiving Emails to music players. Also during night they are kept close to the user and many times work even as alarm clocks.

The invention discloses an improved cellular phone with novelty functionalities. In most cases such improvements apply only to mobile phones, while in other cases such improvements, because of their nature, may apply to all or most electronic handheld devices.

2. Description of Related Art

Related art relative to keypad locking/unlocking systems and display activation methods.

Most electronic handheld devices require the user to control its functionality through a keypad or set of function keys (push-down, switches, rotation keys, touch-pads, touch-screens, etc.) installed on its surface. However, there are certain situations where it is not desirable the effects of accidental key presses. One such situation is when the device is in the pocket of its owner or in a bag.

One solution is to have a “key guard” (also called “key-lock”). This means the user must press a specific sequence of keys before the handheld device is activated. Typically this feature must be manually enabled and, if this is not done, then there is no protection. Even if there is automatic activation of the key guard after a predefined time interval of inactivity, there can be problems. If the time between last key press and the reactivation of the “key guard” is too short, then the user is required to go through the “key guard” again before being able to use the device again after a short pause. If the time between the end of a call and reactivation of the “key guard” is too long, accidental key presses may occur if putted too fast in its bag. This solution may be frustrating to the user, in particular under stress situations when he wants or has to access the functionalities of the device immediately.

Another solution is to have a “holder switch”. This means that on the handheld device there is (usually on the left or right side of it) a mechanic hard-to-move switch which can be turned off or on by the user through a harder (stronger) action, and which locks or unlocks all the other function keys or the keypad. This switch must be turned off or on manually and, if this is not done, then there is no protection. Such switch can also be turned on or off accidentally when the device is in a pocket or bag. The continuous switching on and off before using the device may become user-unfriendly during frequent usage of such device.

Another solution is a hard “coverage surface” (also called flip), which physically covers the keypad of the handheld device. With such coverage the keypad of the handheld device is only accessible when the coverage is flipped to a position where it no longer covers the keypad. The use of a “coverage surface”, while physically preventing accidental key presses when in a position covering the keypad, adds an unwanted complexity in the use of the device, requires additional manipulation from a user before the device may be used, and may be inconvenient and user-unfriendly to some users.

Another solution is to analyse the electric characteristics of the device holder with contact sensors, in particular the skin of the hands of the user. This means that on the handheld device there are some electronic sensors that check skin electrical characteristics (e.g. galvanic skin response) or mechanical ones (e.g. pressure) each time a key is pressed and unlock the device if such characteristics match certain parameter values. Such system requires the device to be surrounded by metallic sensors while most devices have just a plastic case, and this can add a certain hardware complexity and costs to the device, as well as compromising the outside form and look & feel of such device. The user has to touch the handheld device always in the same points (where the sensors are located). An additional inconvenience is that such system alone won't work when the user has gloves/dirty hands or the device is protected inside a plastic or cloth.

Some prior-art patents solving the problem of an automatic and non-automatic keypad lock/unlock and/or automatic display activation will be disclosed below.

U.S. Pat. No. 4,670,747 (Filing date Nov. 19, 1985/Motorola Inc.) discloses a method where a user selects a specific icon on the display to lock the device and then has to select another specific “unlock” icon to unlock it again. A drawback of such system is that the same sequence of keystrokes does not always activate the lock. Moreover, once the lock has been activated only a single keystroke is required to deactivate the lock. This is disadvantageous for a cell phone because it is very easy to accidentally activate a single key.

U.S. Pat. No. 5,241,583/EP0453089/GB2243117 (Filing date Apr. 17, 1991/TECHNOPHONE LTD/Nokia Mobile Phones Ltd) discloses a cell phone with keypad including a plurality of externally accessible keys which can be disabled (e.g. the keypad can be locked) to prevent accidental actuation thereof by performing a predetermined order of keystrokes using two of the keys which ordinarily have an alternative function associated therewith. Thus, for example, depression of the # key followed by the ON/OFF key temporarily enables the keypad lock. Simply repeating the same keystrokes can deactivate the lock. An inadvertent depression of two keys in succession and in a given order is less probable, so much that it can be used for deactivating the keypad lock. A drawback of such method is that the user is always required to lock and unlocks the keypad manually. If such action is forgotten, no protection exists. Also unlocking always the phone may be frustrating to frequent-users.

U.S. Pat. No. 5,805,084 (Filing date Aug. 8, 1996/Nokia Mobile Phones Ltd) discloses a method whereby the protection of the keypad against inadvertent keystrokes is realized by checking whether the user presses and holds a specific key for a given delay period. When the keypad lock is on, the telephone does not react to any other keypad command except predetermined unlocking signals, which is a sequence formed by two determined keystrokes. Only when the first and second deactivating signals are correct, the deactivation succeeds, the telephone is returned to the same stand-by mode where it also would have ended directly after the call, if the keypad lock had not been activated. A drawback of such method is that the user is always required to lock and unlocks the keypad manually. If such action is forgotten, no protection exists. Also unlocking always the phone may be frustrating to frequent-users.

U.S. Pat. No. 5,987,311 (Filing date Dec. 27, 1996/Ericsson Inc) discloses a method of enabling a keypad when the antenna is extracted. The greatest and only drawback of such system is that almost all electrical handheld devices today have no extractable antenna anymore, but integrated inside the device.

U.S. Pat. No. 5,864,765 (Filing date Feb. 28, 1997/Telefonaktiebolaget LM Ericsson) discloses an automatic method to lock the keys on a mobile telephone terminal keypad, where the keypad is automatically locked after a defined period of inactivity (“Tlock” time). The user has then to press a defined key for a period of time to activate the keypad again. A drawback of such system is that an inadvertent key press may happen while the keypad is not locked yet (e.g. while putting the phone in a bag) and the unlock may happen automatically when an object presses a key for a longer period. While the system solves the problem of automatically locking the keypad, it does not solve the problem of automatically unlocking it, so it may be frustrating to frequent-users.

Patent SE9803762 (Filing date Nov. 3, 1998/ERICSSON TELEFON AB L M) discloses the basic use of sensors for changes in physical properties to activate keypad lock or answer functions when the phone is put down or picked up. At least one sensor is sensitive to acoustic variation or a change in resistance, impedance, capacitance, inductance, acceleration, IR radiation, temperature, and is used to activate a keypad lock and/or answer function. One sensor is on one side of the phone and another is on the other side, so they both can be reached at the same time by two or more fingers. The only drawback is that the user has to touch the phone always in well-defined points that may be unnatural for him. Usage with gloves and dirty hands is also not possible.

Patent US2001044318/EP1109382/GB2357400 (Filing date Dec. 17, 1999/NOKIA MOBILE PHONES LTD) discloses a terminal for a communication system comprising detector means that are arranged to detect if there is a contact between at least one surface of the terminal and the skin of the user of the terminal. A drawback of such method is that the terminal requires a metallic cover or metallic sensors on its cover (affecting design and production costs) to detect the user skin and that the user has to hold the phone always in the same way (touching in some way the sensors). In case a sensor array is implemented, this should be very large covering almost the whole surface and increasing so production costs, hardware complexity and space requirements. Usage with gloves or dirty hands is in most cases not possible. The sensors would be also easily damaged. Claim #15 discloses the use of proximity capacitive sensor placed on the inner surface of the cover of the terminal capable to detect the user skin tissue capacitive characteristics within 5mm of distance. Also this method requires the user to touch the handheld device always in the same points (in close proximity where the sensors are located) or is practicable only with sensor arrays. Other disclosed sensors are temperature and pressure ones. Users always touch their phones in different points and with different hand patterns (sometimes the skin may be even 3-4 cm distant from the surface in some points) changing from hand to hand and from time to time, making the system reliable only if sensor would be everywhere.

U.S. Pat. No. 6,801,765 (Filing date Dec. 27, 1999/Samsung Electronics Co., Ltd.) discloses a method for locking and unlocking a mobile telephone setting a locking mode by receiving a locking voice, a locking-wait time and a locking number; receiving a locking voice when there is a key input in the locking mode; partially releasing the locking function when the received locking voice is identical to a registered locking voice; switching an operation mode of the mobile telephone to an idle mode, after partially releasing the locking function; and switching the operation mode of the mobile telephone back to the locking mode, when there is no key input in the idle mode until the locking-wait time has elapsed. A drawback is that the user still has to record a locking voice and speak the same locking voice when he wants to switch to the idle mode.

Patent application 20020103616 (Filing date Jan. 31, 2001/MOBIGENCE, INC.) discloses a method of automatically activate a touch-screen display when the stylus used for the touch-screen is absent from a receptacle, that receives the stylus on the device. Of course such system will work fine, but only for devices having a touch-screen and a stylus receptacle.

U.S. Pat. No. 6,985,137/EP1284450 (Filing date Aug. 13, 2001/Nokia Mobile Phones Ltd) discloses a method and system for preventing unintended touch-pad input resulting from accidental touching of a touch-pad device in an electronic device. A drawback of such method is that it works only for touch-pads.

Patent application US2004203604/DE10235546 (Filing date Mar. 25, 2002/Agere Syst) discloses a method where the keyboard is unlocked when a predetermined sequence of keys is pressed. The length of time a key is pressed can also be taken into account.

Patent application US20060030367/US20040204123 (Filing date Dec. 30, 2002) discloses a method of unlocking a keypad based on the time a key is kept depressed.

Patent application US20030443218 (Filing date May, 22, 2003/Motorola Inc) discloses a communication device with automatic display and lighting activation through temperature, proximity and acoustic pressure sensors near the microphone and earphone, sensing the distance between the device and the user. If such distance is greater than a defined threshold, the display is activated. The intensity of the light may be in function of the ambient light. A drawback is that the display activation will happen many times also when an usage of the device is not planned, for example when putting the device from a pocket on a shelf (where the sensors won't sense any user proximity).

Patent application US20050066091 (Filing date Jul. 23, 2004) discloses the use of light sensors and a processor to lock/unlock a keypad or any other user input device.

Patent application US20060046694/TW093126335 (Filing date Oct. 27, 2004/Asia Optical) discloses a method for automatically deactivating a keypad lock, comprising the steps of: 1) determining whether or not it receives a first numeric key signal from the keypad, 2) then waiting for a first waiting delay to determine whether it receives a plurality of numeric key signals, 3) and at last determining whether it receives a dialling signal in a second waiting delay, 4) if all answer of above is yes, the keypad lock being deactivated and a communication connection being set-up.

Patent application US20060012577 (Filing date Jul. 16, 2004/Nokia Mobile Phones Ltd) discloses a device comprising at least a touch-screen and a keypad for providing input functions. The keypad is provided with a key lock operation comprising an active state and an inactive state. The active state is adapted to disable at least part of the input functions of the keypad, and the inactive state is adapted to enable the input functions of the keypad. The device comprises a detector for detecting when a stylus is in proximity with the touch-screen and a key lock activator for setting the key lock into said active state when the detector provides indication of the proximity of the stylus.

Patent application US20060075250 (Filing date Sep. 24, 2004) discloses the use of pattern recognition algorithms to lock/unlock the touch-pad of an handheld device.

Related Art Relative to User Identification

Many US (e.g. U.S. Pat. No. 6,788,928) and not-US patents (e.g. EP1545102) disclose the use of fingerprint recognition in mobile devices. While these methods are very reliable and accurate, they require additional and sensible hardware, which increment system complexity and occupy precious space on the device surface.

Patent application US20060012677 (Filing date May 13, 2005/Neven, Hartmut S R.; (Aachen, Del.), Neven; Hartmut) discloses a mobile phone with face recognition identification. While this method is quite reliable and accurate, it does not work in all light conditions a mobile phone is used. Also the phone has always to be at the same position & distance to the user, which may be frustrating in some situation.

Related Art Relative to Automatic Answer Systems for Incoming Calls

U.S. Pat. No. 7,187,952 (Filing date Mar. 7, 2005/Lin, Cheng-Lung) discloses a phone accepting incoming calls based on motion properties of the phone.

Related Art Relative to Variable Profiles (Ring-Tones)

Patent application US20050136842 (Filing date Dec. 19, 2003/Fan, Yu-Fu; Chiu, In-Ga) discloses a mobile phone whose profile changes automatically measuring a current environmental noise value of ambient noise surrounding the mobile phone.

Patent application US20060105817 (Filing date Nov. 18, 2004/IBM) discloses a mobile phone whose ring-tone volume can be reduced by moving the device.

Patent application US20060148490 (Filing date Jan. 4, 2005/IBM) discloses a mobile phone whose ring-tone changes depending on user behaviour and/or device location.

Patent application US20070037605 (Filing date Oct. 18, 2006/Logan, James) discloses a mobile phone whose profile (ring-tone) is controlled by its absolute position (through GPS system) or relative to another object. Also time of the day, ambient light and other parameters may be considered to switch the correct profile.

Related Art Relative to User Input Interfaces

Patent application US20050197145 (Filing date Jul. 27, 2004/SAMSUNG ELECTRO-MECHANICS CO., LTD.) discloses a mobile phone capable of input of phone number without manipulating buttons of a keypad but though inclination and vibration control.

Related Art Relative to Touch-Pad on Mobile Handheld Devices

U.S. Pat. No. 7,151,528/EP1405298 (Filing date Jun. 6, 2002/Cirque Corporation) discloses a cellular phone with a proximity-based mutually capacitance-sensitive touch-pad that is disposed directly beneath a keypad keymat of a mobile telephone.

Patent US2004263484/EP1642445 (Filing date Jun. 23, 2004/Nokia Corp.) discloses a touch-pad mouse located on the backside of a device. A drawback of such position is that the backside usually doesn't contain any user interface and many times is used for the battery. The touch-pad user interface is also not very suitable on small surfaces, like the side of a mobile phone.

Patent application US20070040812 (Feb. 27, 2006/Tang, Kuan-Chun; Chen, Wen-Jun) discloses an Internet phone with a touch-pad area that can operate in different modes, including a telephone mode, a handwriting input mode and a cursor mode.

Therefore, it would be advantageous to have some additional systems and methods to increment user friendliness and automation of many frequent operations on such device. Also to have additional and innovative functionalities on such device is desirable.

### BRIEF DESCRIPTION OF THE DRAWINGS

Accompanying figures are incorporated in and form part of the specification, serve to further illustrate various embodiments and to explain various principles and advantages all in accordance with the present invention.

FIG. 1 illustrates an exemplary embodiment of the disclosed cellular phone with some of its ambient sensors, a display, a keyboard and the touch-pad area.

FIG. 2 illustrates the valid longitudinal and lateral inclinations at which the keypad is enabled.

FIG. 3 is a logic flow diagram that illustrates a key press action process (intentional or unintentional) and the checking of the device inclination.

FIG. 4 is a logic flow diagram that illustrates a key press action process (intentional or unintentional) and the checking of objects in front of the device display.

FIG. 5 shows the current displacement (electric field sensing) on the backside of a handheld device caused by the user hand.

FIG. 6 shows a hypothetical configuration screen for the different keypad lock/unlock methods.

FIG. 7 is a logic flow diagram that illustrates the process of automatically connecting to an incoming call.

FIG. 8 shows a mobile phone from a perpendicular perspective up down and in two different verses, one upside up and the other upside down.

FIG. 9 shows a hypothetical configuration screen to setup the automatic profile changing depending on the verse.

FIG. 10 shows the curved touch-pad area zoomed together with the thumb finger to control it.

### CROSS REFERENCE TO RELATED APPLICATIONS

Provisional U.S. Pat. No. 60,914,627 (EFS ID 1725702), filed Apr. 27, 2007, and titled “Cellular phone”.

The entire content of the above listed provisional US patent application is hereby incorporated by reference.

### SUMMARY OF THE INVENTION AND DETAILED DESCRIPTION OF THE PREFERRED EMBODIMENT

The innovative improvements object of this invention are disclosed relatively to a “mobile phone”. This can be either a “cellular phone” or a “wireless phone” connected to a base station. The cases where the improvements may apply also to non-“mobile phones”, such as music players, PDA, etc., are expressively disclosed referencing to a “handheld” device, which refers to any of the electronic handheld devices mentioned above or an equivalent. In such case it should be understood that the electronic handheld might be of any type and have different functions and user interfaces.

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings.

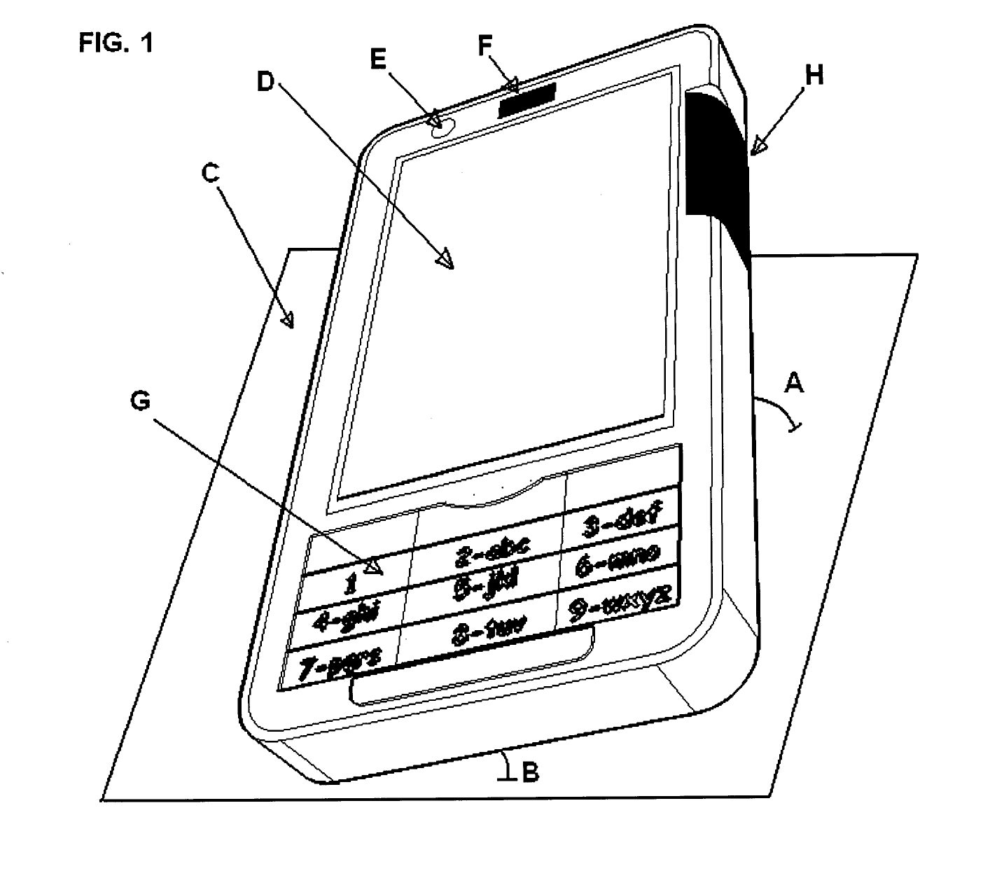

Referring to FIG. 1, an exemplary communication device is shown. The communication device, for example, is a cellular telephone (as illustrated), but for many of the disclosed innovations it could be any type of electronic handheld device with a user input interface, for example a cellular phone, a PDA, a multimedia/music/MP3 player, a remote controller, etc.

FIG. 1 shows its lateral [A] and longitudinal [B] inclination relative to the horizontal plane [C]. The horizontal plane is an imaginary plane perpendicular to the gravitational field and so tangent to the earth surface. [D] is the display of the phone, used to give visual feedback to the user and allow him to navigation through the functions of the device and configure it. [E] is a millimetre-size presence sensor for any object in front of it. [F] is a camera used for video-phone calls. [G] is a keypad to control the functions of the device. [H] is the lateral curved touch-pad.

The handheld device has a key-based user input interface to control its functionalities ([G] of FIG. 1). In the following description, the term “keypad” and “key” refers to any user input interface, such as a keypad or any function key (push-down, switch, rotation-key, touch-pad, touch-screen, etc.).

The handheld device has a user output interface to inform him about the different functions, state, etc. In the following description, the term “display” refers to any user visual output interface, such as a led display, LCD, OLED, active or passive matrix display, etc.

One innovative feature of following invention is to provide some improved and completely automatic techniques for preventing the effects of inadvertent depression of any key on an handheld device and/or automatically activate the display of a handheld device. The systems and methods object of the first part of this invention lock or unlock (enable of disable) automatically the keypad of the handheld device based on the values of some ambient parameters or user behaviour, being one, all or a combination of methods (A), (B) and/or (C). It should be understood that the used system and method might be based on only one of such systems, on all or on a combination of them, depending on the already-available sensors, cost of the device, use and scope of it, etc.

A) Check the device inclination relative to its longitudinal and/or lateral axes. Usually handheld devices are used at defined inclinations when held in the hands of the user so that he can look at the display at the best angle, but are in others when inside a pocket or bag. The inclination is measured through an inclinometer or 3D-sensor, which can be of any type (mechanic, electric or electronic) and embedded inside the device itself (usually as millimetre-small integrated circuit). There are currently inclinometers on 1 and 2 axes (longitudinal and/or lateral) as electronic integrated circuits, just some millimetres in size with low/medium precision (enough for the scope of this function) and which cost just some cents in large productions. Some modern cellular phones already include 3D-sensors that can be used for the scope with just an additional software-only system.

The method (A) includes the steps of: (a) defining an inclination range at which the device is used (for example when in the hands of a user); (b) whenever a key is pressed checking the inclination of the device; (c) in function of the inclination, lock (disable) or unlock (enable) the device keypad.

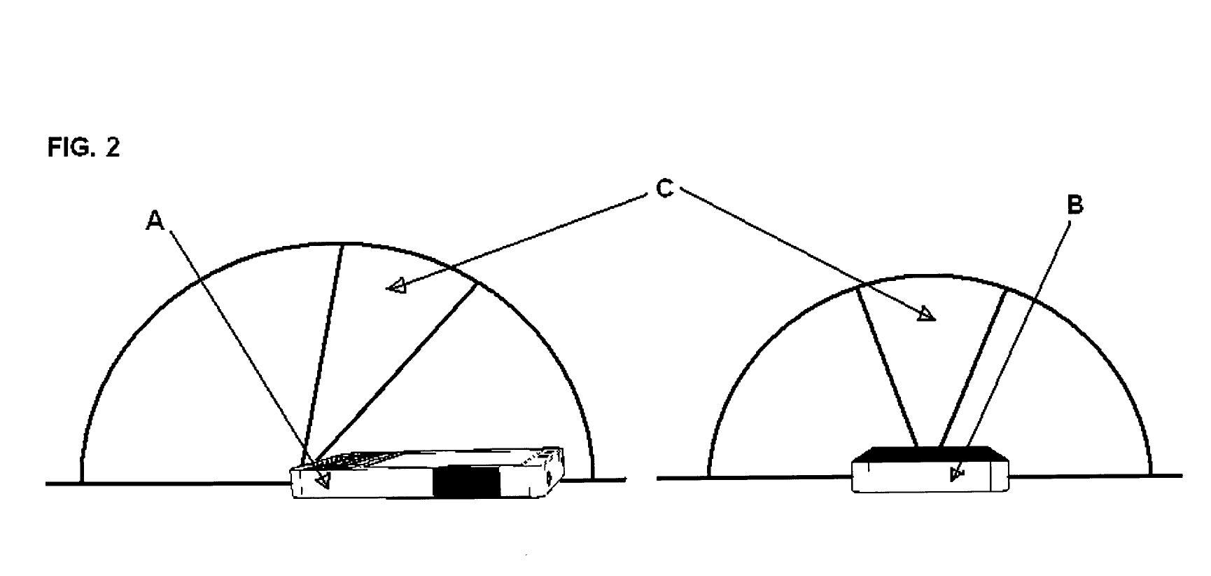

FIG. 2 shows a mobile phone possible longitudinal [A] and lateral [B] inclination. The gray area [C] shows the inclination range that will unlock (enable) the keypad. Whenever the phone longitudinal and/or lateral inclination is within this range, the keypad will be enabled. When outside of such range, it will be locked (disabled).

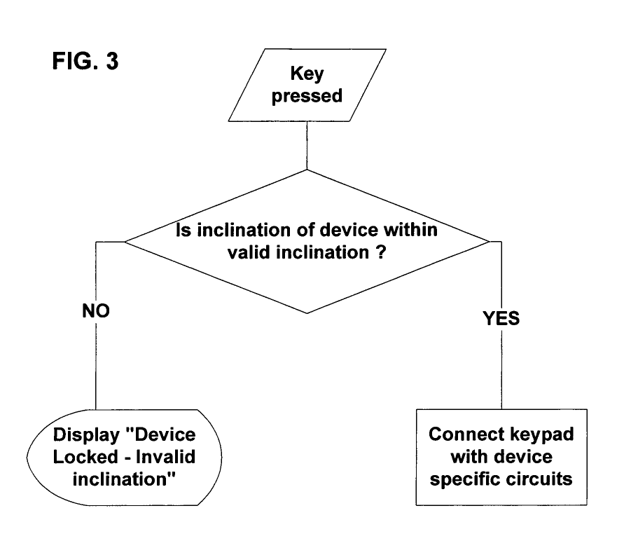

FIG. 3 shows the logic flow diagram of a key press and the check for the device inclination. In case the inclination is unusual, the key press will have no effect and a message may be shown on the display.

The used axis (longitudinal and/or lateral) as well as the valid inclination ranges (shown on FIG. 2 as gray area [C]) may be configurable by the user and may vary depending on his preferences.

Depending on the inclination of the device is also possible to automatically switch the display or display backlight on. As soon as the processor measures a valid inclination for a time longer than a defined threshold, it sends an activation signal.

B) Check the presence of objects in short-distance in front of it, usually above the display. No object for a certain distance, e.g. 20 cm., above the display will be interpreted as non-locking (enabling) distance, while the presence of objects in short distance, e.g. the cloth boundary of a bag, will be interpreted as unusual and so will lock (disable) the keypad. Such presence may be checked with different presence sensors, for example capacitive, ultrasound, optical, IR sensors or an equivalent. In the embodiment of FIG. 1 the sensor [E] will be used. Usually handheld devices are used by the users at a given distance that is greater than the distance between the device and a cloth boundary of a pocket or bag. Such sensor has millimetre size and is implemented in some part around the display. Some sensors allow also to be implemented behind the cover, being so invisible to the user and adding elegance to the device.

The method (B) includes the steps of: (a) defining a minimum distance at which the device is used (for example when in the hands of a user) measured from some part around the display; (b) whenever a key is pressed checking the presence of an object within such distance; (c) in function of the presence lock (disable) or unlock (enable) the device.

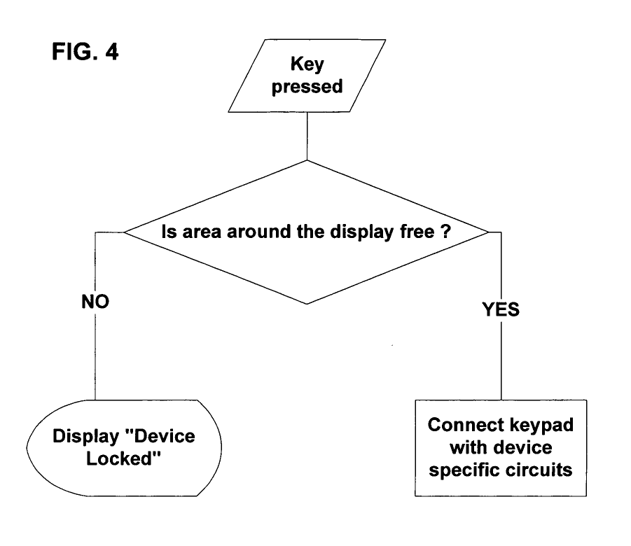

FIG. 4 shows the logic flow diagram of a key press and the check for the presence of objects in front of it (over the display). In case an object within a defined distance is identified, the key press will have no effect and a message may be shown on the display.

Regarding point (B), many handheld devices have a camera just close to the display. If such is the case, the camera auto-focus sensor or a camera shot may be used to identify the presence of an object within such distance disclosed in point (B).

Regarding point (B), many handheld devices have a loudspeaker just close to the display. If such is the case, an echo returned from an acoustic or ultrasound signal sent from such loudspeaker may be used to identify the presence of an object within such distance disclosed in point (B). The checked characteristics being the time delay, frequency shift, rumours, waveform deformations, etc. of such echo.

C) Check the presence of the user's hand in any position behind the backside of the handheld device using electric field sensing, being such system capable to distinguish electric/dielectric/permittivity characteristics and field displacement of a non-metallic biological tissue (the user's hand) from any other non-biological substance (any object close to the device in a bag or pocket). Usually a user touches a handheld device always in close but different points, so touch sensors or local close-proximity sensors as of previous-art patents (e.g. EP1109382) are not reliable enough since they require some training and constraints to the user, which is not acceptable. Sensor arrays would increase hardware complexity, costs and require much space, which is also not acceptable. The two systems disclosed here are capable of sensing the user hand at a distance of some centimetres in any position/pattern behind and close the backside of the device and sense its electrical properties to distinguish it from non-human objects. The hardware is in both cases limited to a couple of plates, while the software complexity acceptable. The user has not to accomplish any rule or method in touching the device, which means he can use the device the same way he was doing it before.

Two methods, one using “electric field sensing” (C1) and one using “electrical potential sensing” (C2) will be disclosed in summary in the following 3 paragraphs. What is object of current invention is not the electric field sensing method with its details, but the usage of such techniques to unlock (enable) a keypad and/or automatically activate a display and/or state sensitive menus. It must be understood that the variations of such systems may be many; but all are based on the same principles (sensing of hand-specific interferences on one or more electric fields behind the device) and differ only for technology used or other minor details.

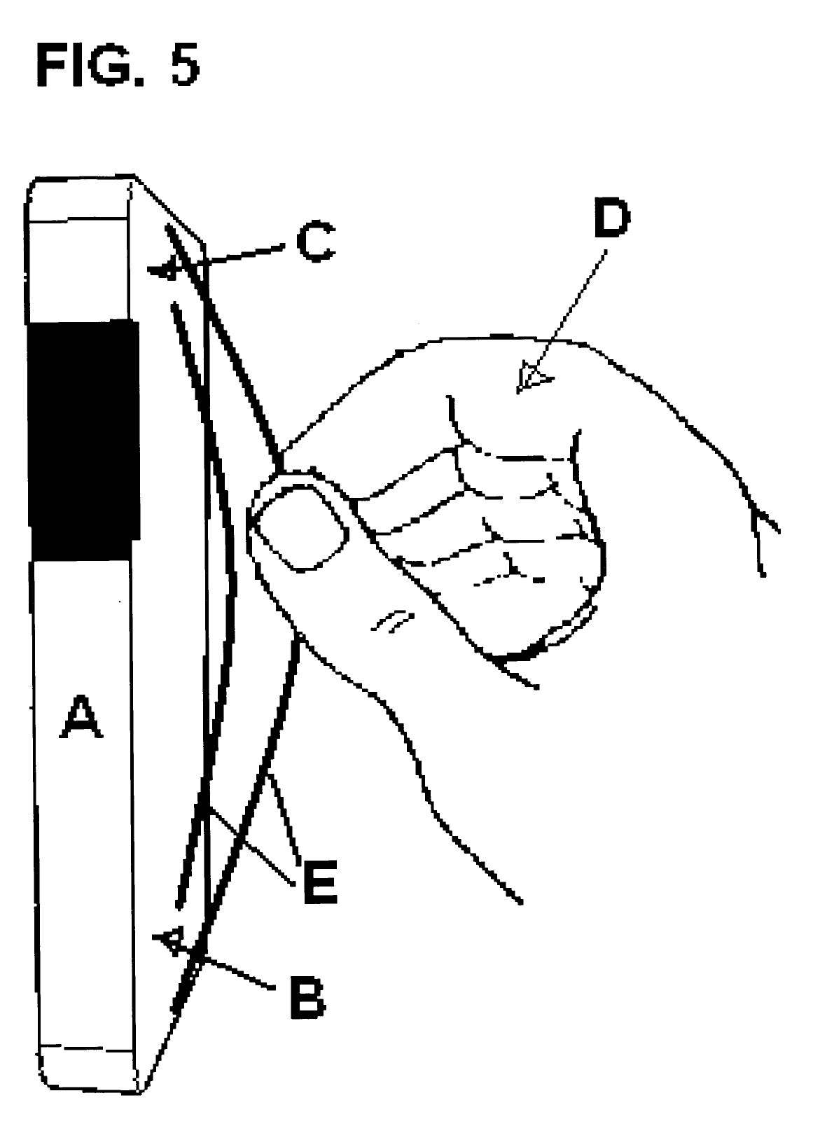

C1) Sense the hand interference in an electric field. FIG. 5 shows the backside of a handheld device [A] and a user hand [D] coming close to it. An electrical potential (voltage) is created between an oscillator electrode [B] and a virtual ground electrode [C] (both placed behind the cover and so not visible in the drawing). A virtual ground is an electrical connection kept at zero potential by an operational amplifier, allowing current IR to ground to be measured. The receiver [C] may be one or more than one, depending on the requested precision and reliability. A more complex variation of the standard electric field sensing model is to use more transmit and receive plates located at different extremities/edges of the device backside and which generates many intercepting fields. The potential difference induces charges on the electrodes, creating an electric field between the electrodes. If the area of the electrodes is small relative to the spacing between them, the electrodes can be modelled as point charges producing dipole fields. The measurable field strength extends approximately two dipole lengths (distance between the transmitter [B] and receiver [C] electrodes) and more than enough to detect any hand pattern. Since we need to detect only a hand at up to 5-centimetre distance from the device but which could be located anywhere behind it, the height/width of the device (and distance between the dipoles) in the whole extent must be used and is enough for the scope. When a hand is placed in the electric field as in FIG. 5 the amount of displacement current IR reaching the receiver decreases. The hand intercepts electric field lines [E], shunting them to ground, decreasing the amount of displacement current IR reaching the receiver [C]. Such displacement, which is specific to the user hand, may be used to disable the keypad lock (enable the keypad) and automatically activate the display, while the displacement created by other material objects or for example a table or desk may be different in strength and so have no effect on the handheld device. When the handheld device is in the hand of the user, such displacement may be quite specific and used to uniquely identify the status “handheld-in-the-hands-of-the-user”. Also the phase shift and/or amplitude modulation created by the user hand may be considered to identify the hand. Using advanced swept frequency techniques it is even possible to determine chemical parameters of the target object and uniquely identify it from another object. The frequency range suggested for the electrical field is below the MHz limit. The amount of power the user is exposed is insignificant and minor than the one of many other electric/electronic devices. Consumption of such a system is also very low, in particular if executed on a non-continuous basis.

Of course the method disclosed above needs additional electronic circuitry and hardware/software controlling systems to reach the scope, elaborate the receiving signal and manage noise signals. Due to changes in the electric field interactions between the hand of a user and the one of another, as well as from different common holding positions for the handheld device, a calibration of such system may be necessary to trim the handheld device which strengths and patterns will automatically unlock (enable) the device and activate the display. Since electric fields penetrate non-conductors, the electrodes can be hidden, providing protection from weather and wear.

C2) Sense the electrical potential of the target object and/or variations in it. The human body (and so also his hand) has a low electric field that can be sensed by mean of electric field sensors even at medium distances (up to 10 cm) and that could be located somewhere in the backside of the handheld device, preferably behind the cover. Also small variations in it created by its organs (e.g. the heart beat) can be measured and used to identify a user hand from another object. The strength of such field as well as common variation patterns in it may be used together or separately, so that also when the handheld device is placed close to the human body but not in his hands (e.g. in a pocket), differences in such measurements exist and can be distinguished by mean of pattern recognition programs.

Even if currently only 2 electric field sensing techniques have been disclosed, other methods or slight variations thereof may be developed and used without exiting the scope of this innovation.

It should be realized that the previously disclosed systems and methods ((A), (B) and (C)) might work also in conjunction with previous-art and other future-art systems. Particularly useful are these systems when implemented in conjunction with previous-art systems in the case the handheld device is used in unusual situations (e.g. in an unusual inclination while the user is in bed, etc.).

Since more than one of the disclosed methods and systems may be implemented in an handheld device depending on its hardware, software, type of device (cellular phone, multimedia player, etc.), mode of use, etc., an ideal device will have a configuration/options page to refine current user preferences as well as execute some required or optional calibrations. In case the device supports more user profiles (as in most today's cellular phones), such configuration can be associated to a specific profile and vary depending of current selected profile (e.g. varying between sport activities and office time).

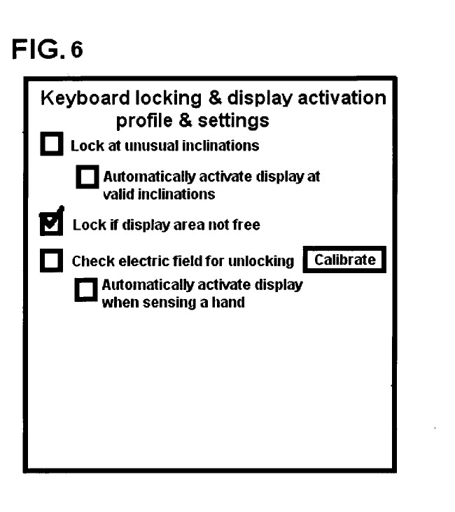

FIG. 6 shows on a hypothetical screen of such device the different options that may be used to automatically lock (disable) and/or unlock (enable) a keypad. Each option may be used alone or in conjunction with others. The different options may be linked as “AND” criteria or “OR” criteria. Since most disclosed methods might have some special situations where they won't work (e.g. the “Inclination based locking” system while a user lies in a bed), there should be also the possibility to allow unlocking the device with standard mechanical switches or keystroke-only methods (e.g. the “Key guard” method).

It must be understood that the screen of FIG. 6 is only a sample subject to major and minor changes and used only to explain how the system may be configurable by the user. The options displayed may vary depending on the supported methods, device type and manufacturer strategy. Also current-art and/or future-art methods could extend such list of options.

The check for the ambient parameters disclosed above may be continuous, done at regular short-term intervals (e.g. once a second), or done just when a key is pressed (power-save mode). While a continuous check will increase responsiveness of the device, it will also increased battery consumption. On the other hand, a check at regular short-term intervals will consume less.

The methods (A) and (C), as already disclosed during their description, may be used also to automatically activate the display of the handheld device. If such checks are done in continuous mode or at regular short-term intervals, they could be used also to control (electronically or via software) the display and/or display backlight. User-friendliness would increase a lot if the display switches itself on automatically as soon as the device is in the hand of the user without requiring the user to press a key first to see it. For method (A) a certain time threshold may be required before the display is activated to avoid automatic activation while the handheld device is being moved or just rotated.

When the display is automatically switched on, a state-sensitive menu may be shown to the user. User-friendliness would also increase a lot if, as soon as the device is in the hand of the user, the user can see a menu with shortcuts to some most-used or recently-used functions depending from current state (e.g. “Incoming call” state/“Not incoming call” state in case of a cellular phone, or “Play” state/“Stop” state in case of a multimedia player).

When an incoming call is detected, the connection is automatically opened without the need to press on any button. Electrical field sensing method disclosed previously is used in conjunction with a presence sensor at loudspeaker level ([E] of FIG. 1). As soon as an incoming call is detected, the electric field sensing method detects a hand behind the device and the presence sensor detects an object (the user ear), the connection is automatically opened. This increase a lot the daily usage, allows the use with dirty hands or gloves and keeps eventual touch-screens clean of fingerprints.

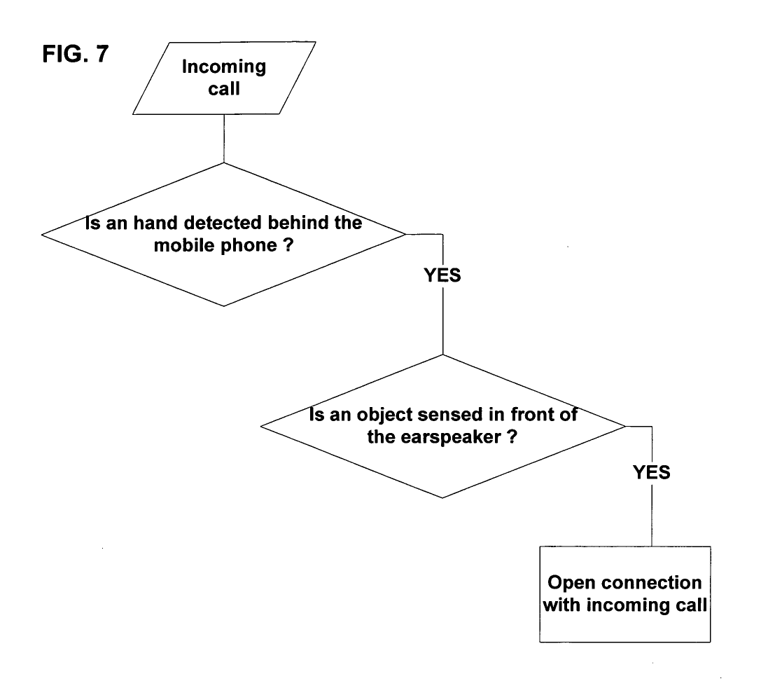

FIG. 7 shows the logic diagram flow from when an incoming call is detected until the connection is automatically opened. As soon as an incoming call is detected, the mobile phone checks and waits to detect a hand behind it. The previously disclosed electric field sensing methods already used to unlock (enable) the keypad can be also used to check the state hand-behind-the-device. Anyway this check alone is not enough and reliable enough, since there are situation where a user after holding the device in his hands doesn't want to answer the call, for example when the caller is an undesired person. Therefore it is necessary to check also for a second state, which is the presence of an object (the user ear) at close distance from the phone loudspeaker. In the embodiment of FIG. 1, for this second sensing, the presence sensor [E] will be used. In fact this is placed very close to the loudspeaker and gets covered when the user puts his ear above it. When the internal processor receives a positive state signal from both the electric field sensor behind the device and the presence sensor close to the loudspeaker, and an incoming call is present, the connection is automatically opened without the requirement to press on any additional button.

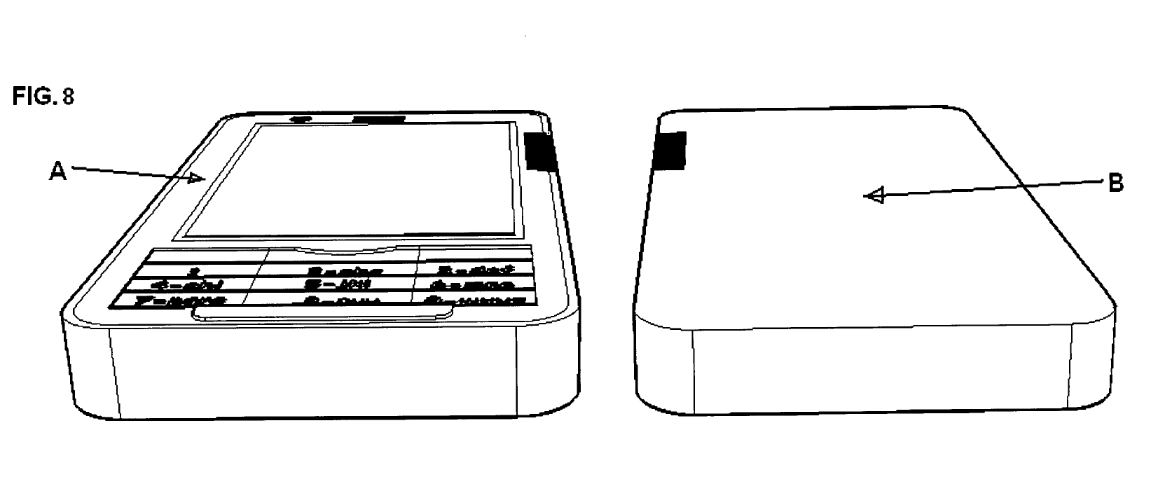

The profile, which includes at least the ring mode (tone, vibration and/or led/visual) and ring volume, of the disclosed mobile phone can be configured to switch depending on the verse how the device is positioned on a table or a flat/fixed surface. FIG. 8 shows the disclosed phone positioned with the display up [A] and with the display down [B]. Previous patents include many methods of changing automatically profile depending on ambient parameters and GPS locations. Nevertheless there are many situations, in particular during office life, where the ambient parameters are the same but another profile is desired. This is the case during a meeting or a conversation. A complete automatic and reliable profile switch is therefore in many situations not possible. The method based on the verse is therefore not automatic, but requires a minimum interaction and is immediately visible and intuitive, without the need of pressing on a small key or switch. So, for example, if the upside of the device of FIG. 1 is put up down (in this case the display in contact with the table as in [B] of FIG. 8), the device switches automatically to a “silent” profile, which notifies of an incoming call with just a low/short vibration or led activation.

Putting the phone in a defined verse has also the advantage that the user always knows what is current profile, while switching profile through a button click tends to be forgotten, in particular is the profile has to be changed frequently during the day. The specific inclination is recognized by reference of an inclinometer or 3D-sensor embedded in the device itself and already used for other innovations disclosed with this document. The specific inclination may be monitored on regular intervals as well as being changed first when an incoming phone call is detected. To avoid false interpretations, the specific inclination may also be required to be in this state for more than a threshold value (e.g. 3 seconds). This will allow avoiding interpreting as “silent” mode a situation where the mobile phone is so only by chance, e.g. while the user is joggings or doing sport activities.

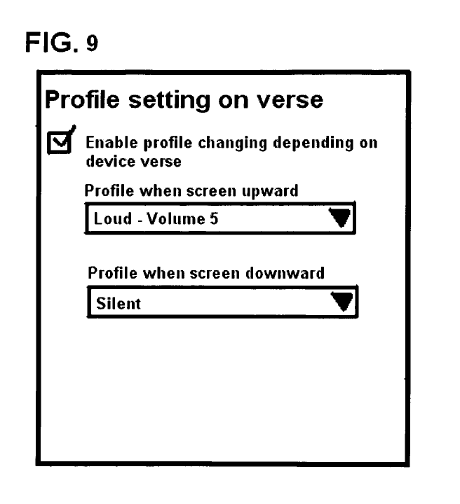

FIG. 8 shows the mobile phone object of current invention in two different verses. In verse [A] is shown the phone over the table with the display upside, while in verse [B] the same phone is shown with the display downside, and so with another profile activated. It must be understood that the differences in profile between the verse [A] and [B] may be configurable by the user. Also the activation of such system may be configurable. FIG. 9 shows an hypothetical screen to configure the profile switch based on device verse. As first option is possible to configure if such profile changing is enabled or not, and in next two controls is possible to associate a specific profile to each verse.

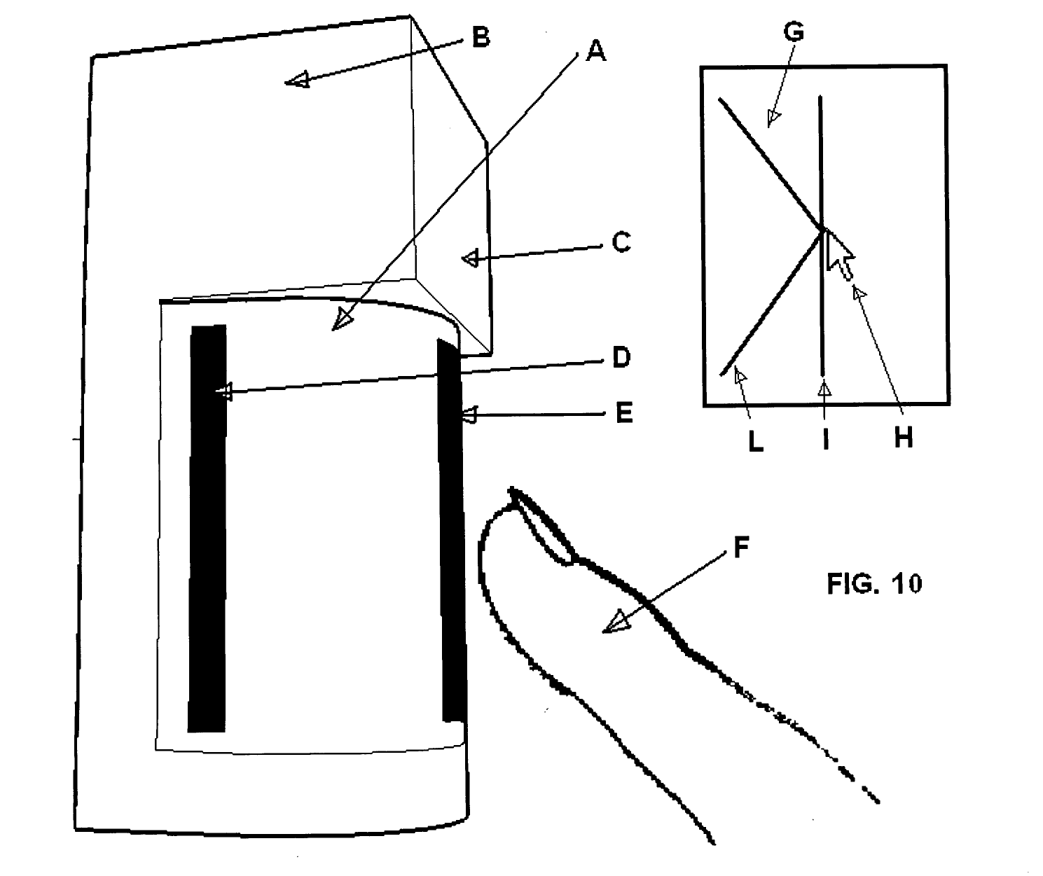

A touch-pad area is built on the lateral side of the device, as shown in [H] of FIG. 1. Since the depth of the disclosed phone is very low and the control of the horizontal axis is therefore not feasible, the touch-pad is curved on three surfaces (side, upper and lower surface), allowing the user to move his thumb finger on any surface and also cross surface without leaving contact with the touch-pad. Curving the touch-pad in this way allows a much more exact control over the mouse or selection cursor and also different behaviours depending on which surface the thumb finger is moved on. So, for example, if the thumb finger is moved up & down on the lateral surface ([E] of FIG. 10), the mouse is moved vertically up & down (path [I] of FIG. 10) while if the thumb finger is moved up & down on the upper surface ([D] of FIG. 10) the mouse pointer is moved up & down and left & right at the same time (oblique concave path [L] of FIG. 10).

FIG. 10 shows in detail the curved touch-pad [A] and different exemplar paths the thumb finger [F] can be moved over. [C] is the lateral side of the mobile phone and [B] the upper one containing the display and the keypad. The display [G] is also shown separately in FIG. 10, with the cursor [H] and two different representative paths [I] and [L] where the cursor may move on. If the thumb finger [F] is moved over the path [E] then the mouse is moved on the vertical and linear path [I]. If the thumb finger is moved over the path [D] then the mouse is moved on the oblique path [L] in case it is not located already on the left side. If this is the case, then the cursor is moved just vertically up & down. The same, but opposite, is the case if the user moves the thumb finger on the path beside the phone (for perspective reasons not shown in FIG. 10, but easily imaginable). The more the path of the thumb finger is moved away from the centreline [E] of the touch-pad and the cursor is located in a central location, the more the movement of the associated cursor will be oblique toward the left or right side of the display. This will allow the user to reach fast his target display area with the use of the thumb finger only and without leaving the touch-pad many times or without complex movements on the curved side of the touch-pad (which are in any case still possible).

Of course the thumb finger movement paths may be slightly different from the disclosed ones as well as the cursor movements in the display. Ideally the behaviour and sensibility of the cursor relative to the thumb finger movements should be configurable. All variations of disclosed touch-pad have anyway in common that the touch-pad is curved and covers more than one surface of the device. Also different behaviour happens depending on the surface region and distance from the centreline the finger is moved on.

The description of the present invention has been presented for purposes of illustration and description but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

This disclosure is intended to explain how to fashion and use various embodiments in accordance with the invention rather than to limit the true, intended, and fair scope and spirit thereof. The above description is not intended to be exhaustive or to limit the invention to the precise form disclosed. Modifications or variations are possible in light of the above teachings. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An electronic handheld device with input keys being locked/disabled and/or a display being activated when the inclination of the device relative to its longitudinal and/or lateral axes is inside or outside a defined range.

2. The method of claim 2, wherein the input keys are mechanic or electronic, push-down, rotational, switch-based, touch-pad, touch-screen or an equivalent.

3. The method of claim 2, wherein the inclination is measured though an inclinometer, accelerometer or 3D-sensor built inside the device itself.

4. The method of claim 2, wherein the valid inclination axes and/or inclination ranges are based on user preferences (configurable by the user).

5. The method of claim 2, wherein the specified inclination must be in the valid range for a defined threshold time before the input keystrokes are considered.

6. The method of claim 2, wherein the inclination is checked continuously, at regular short-term intervals or only when a key is pressed first.

7. The method of claim 2, wherein the method is disabled when the device is in a special state or condition (e.g. when attached at the electrical network or when plugged in the car holder).

8. An electronic handheld device with input keys being locked/disabled if an object is sensed in front of the device display within a certain distance.

9. The method of claim 8, wherein the input keys are mechanic or electronic, push-down, rotational, switch-based, touch-pad, touch-screen or an equivalent.

10. The method of claim 8, wherein the sensing for an object is done by a capacitive sensor, an ultrasonic sensor, an IR sensor or an equivalent capable to sense the presence of not-metallic objects within a certain distance.

11. The method of claim 8, wherein the sensing for an object is done analysing a shot from a camera.

12. The method of claim 8, wherein the sensing for an object is done analysing an echo (time delay, frequency shifts, rumours) returned by an acoustic or ultrasonic signal created by the device loudspeaker.

13. The method of claim 8, wherein the specified threshold distance is based on user preferences and configurable by the user.

14. The method of claim 8, wherein the area around the presence sensor must be free for a defined threshold time before the input keystrokes are considered.

15. The method of claim 8, wherein the presence of an object is checked continuously, at regular short-term intervals or only when a key is pressed first.

16. The method of claim 8, wherein the method is disabled when the device is in a special state or condition, particularly when attached at the electrical network or when plugged in the car holder.

17. An electronic handheld device with input keys being unlocked/enabled and/or a display being activated when the hand interference in an electric field created behind or around the handheld device is detected.

18. The method of claim 17, wherein the input keys are mechanic or electronic, push-down, rotational, switch-based, touch-pad, touch-screen or an equivalent.

19. The method of claim 17, wherein the interference in the electric field is the current displacement and/or phase shift and/or amplitude modulation change and/or swept frequency responses created by the user hand.

20. The method of claim 17, wherein the interference signal must be detected for a defined threshold time before the input keystrokes are considered.

21. The method of claim 17, wherein the valid interference intensity required to enable the keypad and/or activate the display can be calibrated by the user.

22. The method of claim 17, wherein the interference is checked continuously, at regular short-term intervals or only when a key is pressed first.

23. The method of claim 17, wherein the method is disabled when the device is in a special state or condition, in particular when attached at the electrical network or when plugged in the car holder.

24. A mobile phone having a locked status and using the electrical response signal generated by an electric field through the user hand in contact with a receiver plate as user identification method to unlock it.

25. The method of claim 24, wherein the electrical response signal is the conductance of electricity through the user hand (body salinity identification).

26. The method of claim 24, wherein the electrical response signal is the electrical response of the user hand at different frequencies.

27. The method of claim 24, wherein such method is used in conjunction with other identification methods, in particular password or PIN entry methods.

28. The method of claim 24, wherein the mobile phone switches to a hard-locked state if such identification method fails, without allowing the user to retry it in an unlimited number of times.

29. A mobile phone that opens the connection to incoming calls automatically without any key press when a hand is sensed behind the device and an object close to the loudspeaker is detected.

30. The method of claim 29, wherein the hand is sensed by mean of electric field displacement sensors.

31. The method of claim 29, wherein the hand is sensed by mean of proximity sensors, in particular capacitive or ultrasound sensors.

32. The method of claim 29, wherein an object close to the loudspeaker is sensed by mean of a presence sensor.

33. The method of claim 29, wherein also an audio threshold signal close to the microphone is required to open the connection.

34. The method of claim 29, wherein the connection, after being opened, is automatically closed when the hand is no more sensed behind the device.

35. A mobile phone whose profile changes or can be configured to change depending on the verse how it is positioned on a quiet surface (upside up or upside down).

36. The method of claim 35, wherein the profile includes the ring-tone type and/or ring volume and/or silent mode.

37. The method of claim 35, wherein the verse is measured though an inclinometer, accelerometer or 3D-sensor built inside the device itself.

38. The method of claim 35, wherein the profile for the upside up and the profile for the upside down is configurable by the user.

39. The method of claim 35, wherein the device has to be in the required verse for a defined threshold time and/or without movements and/or vibrations before the profile is changed.

40. The method of claim 35, wherein this method can be disabled by the user.

41. An electronic handheld device with a touch-pad curved on more than one surface, one of which is the lateral side.

42. The method of claim 41, wherein the touch-pad surface is rounded between the lateral side and the upper side (front-side) of the device.

43. The method of claim 41, wherein the touch-pad surface is rounded between the lateral side and the lower side (backside) of the device.

44. The method of claim 41, wherein the touch-pad lateral surface is on the right side of the mobile cellular phone.

45. The method of claim 41, wherein the touch-pad lateral surface is on the left side of the mobile cellular phone.

46. The method of claim 41, wherein the touch-pad is a capacitive touch-pad.

47. The method of claim 41, wherein the touch-pad is an electromagnetic touch-pad.

48. The method of claim 41, wherein the touch-pad is a resistive touch-pad.

49. The method of claim 41, wherein the touch-pad behaves differently depending which surface region is touched.

50. The method of claim 41, wherein the horizontal movement of the cursor is a function how far is the touched zone on the touch-pad from the centreline.
